(19) United States
(12) Patent Application Publication
(10) Pub. No.: US 2008/0033736 A1
(43) Pub. Date: Feb. 7, 2008

(54) Method to monetize intellectual property assets

(76) Inventor: Richard Bulman, Miami, FL (US)

Correspondence Address: Richard Bulman;No. 904, 888 Brickell Key Drive, Miami, FL, 33131, US

(21) Appl. No.: 11/497,616

(22) Filed: Aug. 2, 2006

(51) Int. Cl. G06Q 10/00

(52) U.S. Cl. 705/1

(57) ABSTRACT

A business method for monetizing imperfect intellectual property assets is provided. The method can include data collection (201), data segmentation (301), determining market demand (401), determining market opportunity (501), conducting ownership inquiries (601), reclaiming and rebranding (701), marketing and promoting rebranded intellectual property (801), and managing rebranded intellectual property assets (901).

### FIELD OF THE INVENTION

The present invention relates to business methods and, more particularly, to methods for categorizing and processing information.

### BACKGROUND

Over the past decade intellectual property assets have escalated in value as they have become more liquid. Intellectual property assets that are absent material defects can be less risky and more marketable. Imperfect intellectual property assets represent a fraction of the total value of all intellectual property assets existing globally. A need therefore exists for valuing imperfect intellectual property assets.

### SUMMARY

One embodiment of the invention is directed to a business method that processes intellectual property assets for extracting value from imperfect intellectual property assets. The method can include identifying imperfect intellectual property assets, reclaiming the imperfect intellectual property assets to produce reclaimed assets, recombining the reclaimed assets to produce recombined assets, rebranding the recombined assets to produce rebranded assets, and monetizing the rebranded assets.

The method can include collecting data regarding the intellectual property assets, and categorizing the data into categories such as actual prior use, scope of use, popularity, status, ubiquity, associated mark, domain name, and novelty. Data collection can include researching a history of the intellectual property assets, and combining old and new intellectual property assets with reclaimed intellectual property assets. The reclaimed intellectual property assets may include a combination of common law and registered trademarks, patents, service marks, domain names, logos, copyrights, trade dress, company and personal names, fictitious names, and brands.

The data can identify one of common law and registered trademarks, patents, service marks, domain names, logos, copyrights, trade dress, company and personal names, fictitious names, or brands including ownership and contact information. Ownership and registration rights can be examined for the intellectual property assets by category. Rights to re-register the intellectual property assets can be acquired for producing reclaimed intellectual property assets. A market demand and use of the intellectual property assets can be evaluated for each category, and the reclaimed intellectual property assets can be marketed and promoted for license or purchase to extract value.

The business method can further include assessing electronic market demand and conventional market demand, and employing a grading system to determine intellectual property value. The electronic market demand can identify criteria regarding products and services, search terms, domain search websites, sales volumes and web search criteria associated with intellectual property assets. The conventional market demand can identify criteria regarding size, industry segment, growth rate and competition. The intellectual property assets can be ranked based on an intellectual property value in view of a comparability index and a market demand for the intellectual property assets. The intellectual property value can be modified in accordance with positive and negative traits. Costs to reclaim the intellectual property assets can be projected, and a recovery revenue can be determined in view of the projected costs. The intellectual property value may be based on one of non-exclusive licenses, exclusive licenses, and a sale of the intellectual property assets.

Embodiments of the invention also concern a business method for monetizing intellectual property assets. The method can include identifying imperfect intellectual property assets, contacting owners of the imperfect intellectual property assets for acquiring or licensing rights, reclaiming use of imperfect intellectual property assets to produce reclaimed assets, evaluating a market demand for the reclaimed assets, and marketing and promoting the reclaimed intellectual property assets. The imperfect intellectual property can include unused, unregistered, abandoned, neglected, out-of-favor and/or terminated intellectual property assets. The reclaimed assets can be rebranded by combining one or more imperfect intellectual property assets to produce rebranded assets, and sold or licensed to extract value. The imperfect intellectual property assets can be combined with trademarks, service marks, domain names, logos, copyrights, patents, trade dress, company and personal names, fictitious names, and/or brands into a unique asset independent of any company, product or service.

A market demand for the rebranded intellectual property assets can be evaluated by ranking imperfect intellectual property assets, acquiring historical information pertaining to a historical value and demand of the imperfect intellectual property, estimating a cost for reclaiming and rebranding the imperfect intellectual property, projecting a reclaimed value based on the cost, the historical value, and the demand, and performing a defect review to update the reclaimed value of the imperfect intellectual property. The projected reclaimed value can be compared with projected licenses or sales returns based on an estimated market size, and the imperfect intellectual property can be revalued in view of the projected reclaimed value.

The business method can further include determining the ownership and registration status of each intellectual property asset, distinguishing among assets as to a basis and need for intellectual property protections, undertaking rights clearance from potential or actual holders on a systematic basis, acquiring intellectual property rights through licenses, securing intellectual property protections for reclaimed and re-branded intellectual property assets, and asserting intellectual property rights where uncontested rights are available.

The business method can further include managing a portfolio re-branded intellectual property asset, licensing re-branded intellectual property assets, and holding the license to one or more re-branded intellectual property assets in a financial portfolio. The holding can include servicing a payment for the reclaimed intellectual property assets, managing the continuity of registrations and protections in place, and securing rights against others;

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a flowchart illustrating a process path for the preferred embodiment of the invention.

FIG. 2 is a flowchart showing the systematic collection of information about intellectual property assets by asset type according to a preferred embodiment of the invention.

FIG. 3 is a flow chart illustrating the operational steps of the data segmentation process according to a preferred embodiment of the invention.

FIG. 4 is a flow chart illustrating the operational steps of determining market demand according to a preferred embodiment of the invention.

FIG. 5 is a flow chart illustrating the operational steps of determining market opportunity according to a preferred embodiment of the invention.

FIG. 6 is a flow chart illustrating the operational steps for conducting an ownership inquiry and acquiring and registering intellectual property according to a preferred embodiment of the invention.

FIG. 7 is a flow chart illustrating the operational steps for the reclamation and re-branding of intellectual property assets according to a preferred embodiment of the invention.

FIG. 8 is a figure illustrating marketing and promotion options according to a preferred embodiment of the invention.

FIG. 9 is a flow chart illustrating the operational steps for the management and/or disposition of intellectual property assets according to a preferred embodiment of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Broadly speaking, Intellectual property assets—such as represented by common law and registered trademarks, service marks, domain names, logos, copyrights, trade dress, company and personal names, fictitious names, and/or brands—may be undervalued because of their illiquidity. Over the past decade, the marketplace has escalated the value of intellectual property assets, particularly in technology-based companies where intangible assets are a predominant part of the value of the enterprise. This surge in worth has fueled interest in finding better ways to make intangible assets liquid to extract financial value. Chief among the ways such assets are being monetized is through licensing and sale, typically through the creation of channels of production and distribution, sometimes through web-enabled software packages permitting assets to be displayed and licensed electronically via the Internet, and less frequently through in-person and automated electronic auction systems.

In general, there is a barrier to sale imposed by the intangible nature of the intellectual property itself, particularly for intellectual property assets other than patents. There are few regulatory guidelines to formalize the qualitative criteria by which intellectual property assets can be evaluated, financed, packaged and sold. Understandably, the value of intellectual property assets can be highly subjective which can include imperfect intellectual property assets. Imperfect intellectual property assets, can include assets that are unused, unregistered, abandoned, neglected, out-of-favor and/or in disrepair, have no ongoing use, no registrations in place, and no active affiliation to persons, companies, products or services. In such cases, these intellectual property assets are seen as having little value.

In general, intellectual property assets are sold without a defined marketplace. For example, there is no established auction or investment market for “reclaimed or re-branded” intellectual property assets whose value is intrinsic to the identity created apart from a company, product or service. Additionally, there is no ready institutional market to hold and manage reclaimed and re-branded assets who have been licensed nor is there a ready market to sell and dispose of large lots of imperfect assets on an institutional basis. The ability to identify, reclaim and extract value from names, pedigrees, products and images, recently lost or long dormant, well known or not, presents a compelling business opportunity for persons or companies looking to build brand equity. Accordingly, the business methods presented herein can extract value in imperfect intellectual property, by reclaiming, recombining, and rebrand imperfect intellectual property, and promote, market and sell the reclaimed and re-branded property into previously non-defined market places.

Intellectual property assets—such as patents and well known trademarks—each registered, well known or immediately usable, and all absent obvious defects (i.e. lawsuits and the like) are generally more liquid and are considered “First Tier”. While “First-tier” intellectual property assets are less risky and more readily marketable, they represent only a fraction of the total value of all intellectual property assets existing globally. The majority of the marketplace is filled with a broad range intellectual property assets of varying types and qualities. In many instances, such imperfect intellectual property assets, including but not limited to assets that are unused, unregistered, abandoned, neglected, out-of-favor and/or in disrepair, have no ongoing use, no registrations in place, and no active affiliation to persons, companies, products or services. In such cases, these intellectual property assets are not in publicly visible and are generally considered as having little value.

Broadly stated embodiments of the invention are directed to a business method that focuses on a process for generating brand identity by harnessing imperfect intellectual property assets, recombining the unique characteristics of intellectual property brands, and extracting value through the license or sale of rebranded intellectual property assets. An implementation of the business method spots and extracts illiquid value from imperfect intellectual property assets by applying a process to realize intrinsic value from the imperfect intellectual property assets.

Aspects of the invention can identify distressed intellectual property assets for possible reclamation. The business method employs intellectual property search systems utilizing public and private databases for identifying imperfect intellectual property. In general, the search systems are frequently key word driven, meaning that the end result needs to be known before the search can be undertaken. However, while advanced searches can occur to identify abandoned marks, there is no focused system of qualification for such data.

The business methods herein determine which assets hold the greatest potential for reclamation and monetization that are critical to an efficient business model. The criteria employed are generally adequate to readily recognize which item among a pool of imperfect assets should be salvaged due to the range and severity of defects presented. Rights clearance is undertaken with the holders of intellectual property assets. In implementation, the business method enables direct contact with asset holders through electronic or in-person mechanisms. Accordingly, holders, unrecognized holders, and past holders—whose rights have been neglected, abandoned or extinguished—can be contacted to facilitate licensing and sales opportunities.

Moreover, the business method reclaims and reconditions defective intellectual property assets. Imperfect intellectual property rights for one or more assets can be combined and re-filed for intellectual asset protection. This function can occur in accordance with laws that require brand identity to be attached to a defined person, company, product or service by use and not as an independent asset recognized apart from such tangible properties. Accordingly, the business methods provide a systematic manipulation of improved assets with new and old features to create independent brand identities. As one analogous example, advertising agencies routinely help to revitalize brands through the creation of new identities and the manipulation of associated images for companies, products and services. However, the activities undertaken are company, product or service driven and do not involve the reclamation and re-branding of imperfect intellectual property assets for future use irrespective of person, company, product or service. Nor is there recognition that such identities can be combined with objects other than a person, company, product or service, such as electronic programs or systems.

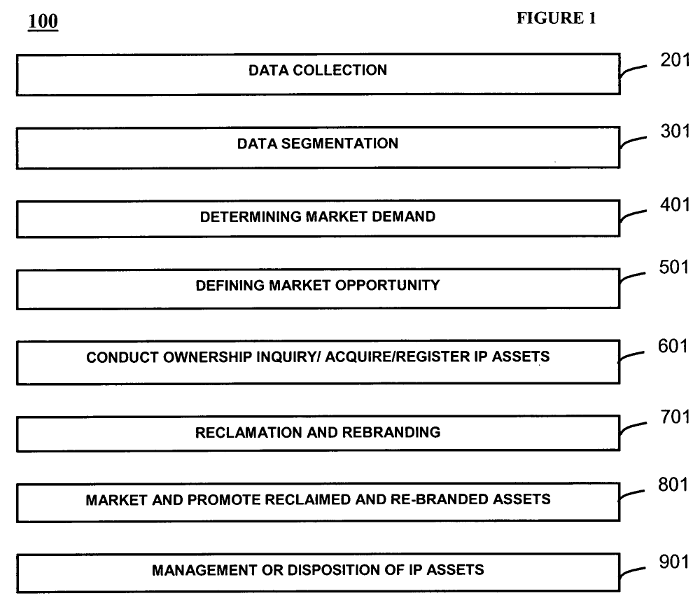

Referring to FIG. 1, a business method 100 for processing intellectual property data is shown. It is understood that the business method 100 can be implemented in any suitable device or system using other suitable components such as a computer having a processor. Moreover, the business method 100 is not limited to the order in which the states are listed in the business method 100. In addition, the flowchart business method 100 can contain a greater or a fewer number of steps than those shown in FIG.

At step 201, data can be collected regarding intellectual property assets. For example, public and private databases can be accessed to retrieve and collect intellectual property asset and ownership data. At step 301, the data can be segmented. For example, collected information collected can be categorized by type and segmented by individual identity. Each individual asset can be evaluated by various criteria and scored and ranked. At step 401, a market demand for intellectual property assets can be determined. For example, each individual asset can be evaluated for marketability according to certain criteria and scored and ranked. At step 501, a market opportunity can be defined. For example, each individual asset can be assessed to account for adjustable traits, likely costs and potential recovery. The asset scores can be combined and each mark re-ranked by category defining the quality of opportunity. At step 601, an ownership inquiry can be conducted to acquire or register the intellectual property assets For example, each individual asset can be examined to account for ownership and registration status. Rights can be cleared and/or acquired based on the ownership and registration status. At step 701, the intellectual property can be reclaimed and rebranded. For example, each re-claimed mark can be evaluated for re-branding purposes. Intellectual property assets can be combined with other reclaimed and new intellectual property to create independent identities. At step 801, the reclaimed and rebranded intellectual property assets can be marketed and promoted. For example, reclaimed and re-branded intellectual property assets can be promoted to a global audience for non-exclusive and exclusive license and purchase. At step 901, the reclaimed intellectual property assets can be managed or disposed. For example, the intellectual property assets that are created as a result of the reclaiming and rebranding can be held in portfolio, or licensed or sold to others for investment For instance, the reclaimed intellectual property assets can be sold individually or in bulk to third parties on a secondary market.

Briefly, the business method 100: (a) identifies intellectual property assets, including but not limited to abandoned, existing, expired or terminated applications and registrations of intellectual property, including common law and registered trademarks, service marks, domain names, logos, copyrights, trade dress, company and personal names, fictitious names and/or brands, (b) categorizes and ranks such assets according to a specific methodology; (c) outlines a method of contacting owners to license and/or acquire the rights to such assets; (d) outlines a method to re-file, re-establish and reclaim use of registrable, non-perfect intellectual property assets; (e) defines a method to package, promote, market, license and/or sell, on a direct and indirect basis, the ownership rights related to these reclaimed IP rights; and (f) defines a method to hold and manage the ownership rights related to these reclaimed IP rights in a portfolio for investment purposes.

In practice, the embodiment of the invention presented by method 100 allows an individual, an organization, or a machine to identify and claim intangible property, in whole or part, and add to it, both tangible and/or intangible aspects, to produce new brand identities including intellectual property. As one example, a global Intellectual Property (IP) system implement the method 100 to acknowledge identities by “class of goods”. The global Intellectual Property system can assess local market demand, assess current brand awareness, and generate brand identities that avoid brand name contention. For example, this may prevent the market from being flooded with brand identities that would reduce demand for intellectual property goods associated with the brand identity. The global Intellectual

Property system can be a single server, a plurality of servers, running enterprise or non-enterprise level software. Moreover, the global Intellectual Property system can be written in an Internet programming language to facilitate the distribution, collection, and dissemination of imperfect intellectual property. For example, a new identify can be added to a brand to produce a manufacture, material, or matter with a new name. The matter can include company name, domain name, or any other association wherein a name is affiliated with a brand identity. In principle, the method 100 can be employed to combine an identity with a product to generate a new name based on market demand.

As another example, an identity can be added to a tangible device, such as a web site that operates a computer program which is self operational. That is, the web site learns from behaviors and performs new activities in response to those behaviors. This can include Internet based or online robotic devices with identities that will interact based on a logic system. In another aspect, the generation of new brand identities as described by method 100 can introduce new products. For example, various software programs and methods for video or audio animation can be purchased and applied to new products. For example, a robot can include a software program and software can be downloaded to the product. Notably, the software can be licensed, bought, or sold to create a new identity for the robot. As another example, software can be licensed for download to an avatar which is a rendering of a visual and audio animation based on a history and combination of information provided to the avatar. The software for the avatar can be bought or sold based on a market demand of the software features such as the audio or video processing. In the context of the example, the method 100 can identify market demand for the avatar, evaluate brand identities, and combine the brand identities with the avatar to generate features for increasing market demand.

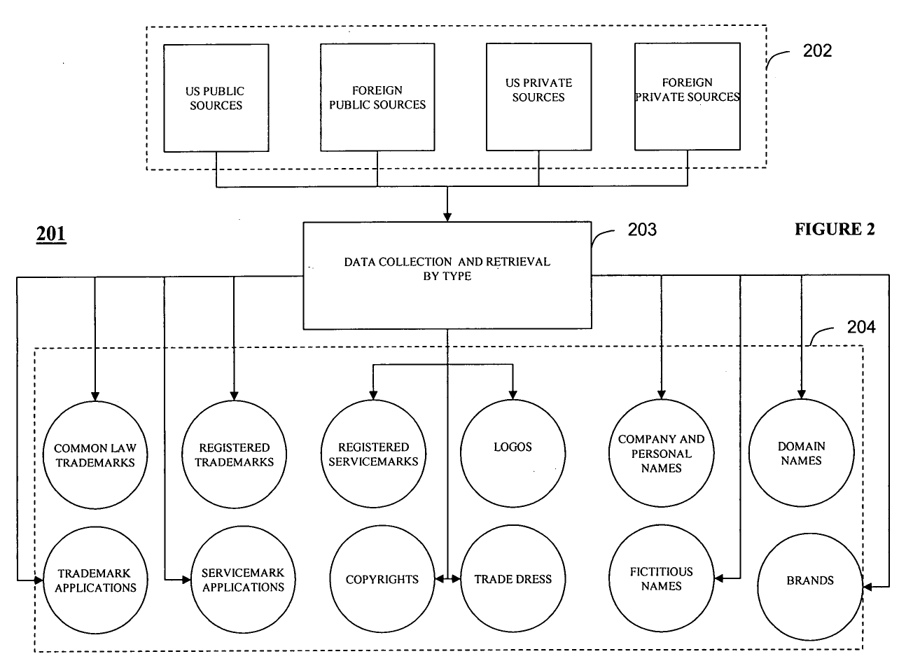

Referring to FIG. 2, a flowchart 201 for systematic collection of information regarding intellectual property assets by asset type is shown in accordance with one embodiment of the invention. In particular the flowchart corresponds with business method step 201 of FIG. 1 regarding data collection of intellectual property assets. It is understood that the business method 201 can be implemented in any suitable device or system using other suitable components such as a computer having a processor. Moreover, the business method 201 is not limited to the order in which the states are listed in the business method 201. In addition, the flowchart business method 201 can contain a greater or a fewer number of steps than those shown in FIG. 2. The business method 201 can include collecting data regarding the intellectual property assets, wherein the data identifies one of common law and registered trademarks, service marks, domain names, logos, copyrights, trade dress, company and personal names, fictitious names, or brands including ownership and contact information.

Information concerning imperfect intellectual property assets can be collected from a variety of sources (202), including but not limited to public and private databases of domestic and foreign intellectual property assets, company and personal names and product brand information. The collected data can be retrieved and organized for segmentation by category and asset (203) using electronic and other means. As one example, common law trademarks can be identified that are not registered, or have been used and require further protection (203). Trademark applications that have not been registered and are set to be abandoned or have been abandoned can also be identified.

The collection of data can further include identifying registered trademarks that have been used and are set to expire or have expired, identifying service mark applications that have not been used and are set to expire or have expired, identifying registered service marks that have been used and are set to expire or have expired, identifying copyrights that have been used and are set to expire or have expired, identifying logos that have been used and are set to expire or have expired, identifying trade dress that have been used and are set to expire or have expired, identifying company and personal names that have been used and are set to expire or have expired, identifying fictitious names and personal names that have been used and require further protections, identifying domain names that has have been used and require further protections, and identifying brands that have been used and require further use and protection. Embodiments of the invention are not limited to the intellectual property assets (204) presented in FIG. 2, which can include more than those shown.

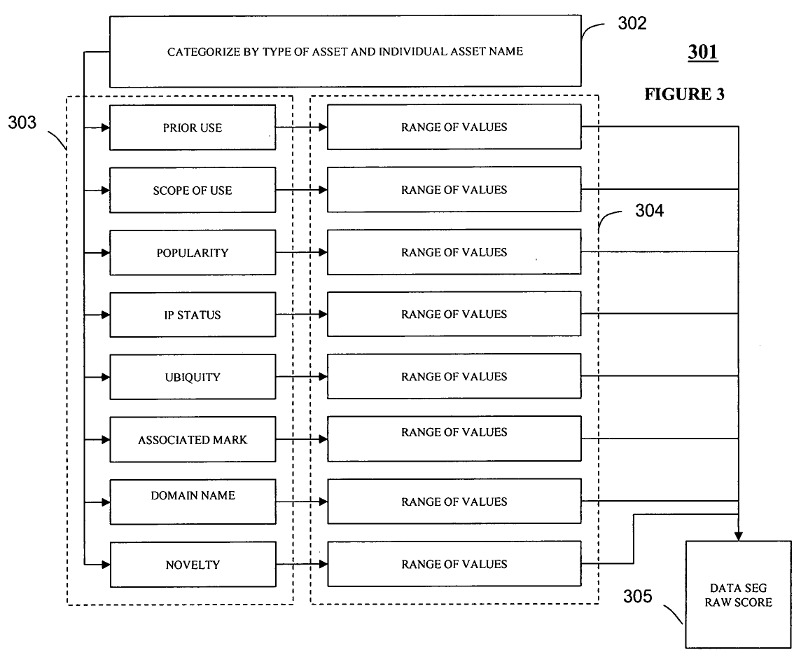

Referring to FIG. 3, a flowchart 301 for data segmentation is shown in accordance with one embodiment of the invention. In particular the flowchart 300 corresponds with business method step 301 of FIG. 1 regarding categorization of intellectual property assets. It is understood that the business method 301 can be implemented in any suitable device or system using other suitable components such as a computer having a processor. Moreover, the business method 301 is not limited to the order in which the states are listed in the business method 301. In addition, the flowchart business method 301 can contain a greater or a fewer number of steps than those shown in FIG. 3.The business method 301 can include categorizing the data into categories comprising at least one of actual prior use, scope of use, popularity, status, ubiquity, associated mark, domain name, and novelty.

For example, the business method 301 can categorize the intellectual property asset by type and name (302). Each individual intellectual property asset can be identified and evaluated upon various criteria, including but not limited to the criteria (304). Each intellectual property asset can then be graded (304) according to the criteria. As one example, information can be collected about the specific intellectual property asset including actual prior use, such as whether or not the mark has been used in commerce and graded (304) accordingly. As another example, information can be collected about the specific intellectual property asset including, geographic scope of use whether said asset has been used globally, by country, regionally, locally or not yet used (303) and graded (304) accordingly. Information can be collected about the specific intellectual property asset including, popularity of the said asset (303) and graded (304) accordingly. Information can be collected about the specific intellectual property asset including, the current status of asset, whether it is a registered and protected asset, is subject to an application in process, is unregistered or has been used and is not in use or is abandoned (303) and graded (304) accordingly. Information can be collected about the specific intellectual property asset including, its ubiquity—whether the mark represents a general concept, is multi-product one product or arcane (303) and graded (304) accordingly. Information can be collected about the specific intellectual property asset including, any associated mark to said asset, whether matched, unmatched or non-existent (303) and graded (304) accordingly. Information can be collected about the specific intellectual property asset including, any associated domain name, whether such domain name is identical, similar to, dissimilar to said mark or whether no domain is associated said asset (303) and graded (304) accordingly. Information can be collected about the specific intellectual property asset including the novelty of said asset, whether the asset is unique, has few similar assets, many similar assets, or exact conflicting assets (303) and graded (304) accordingly. Data for each grade value by criteria can be combined to determine a data segmentation raw score (305) for each intellectual asset listed by category.

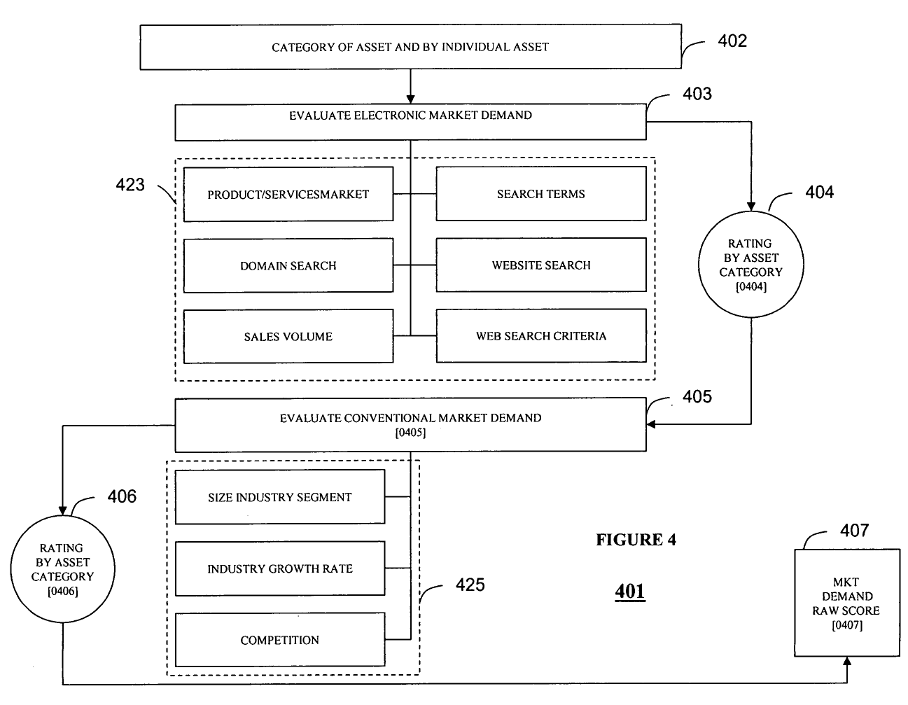

Referring to FIG. 4, a flowchart 401 for determining market demand is shown in accordance with one embodiment of the invention. In particular the flowchart 400 corresponds with business method step 401 of FIG. 1 regarding evaluating market demand for intellectual property assets. Moreover, a grading system can be employed to determine an intellectual property value based on the evaluated market demand. In practice, each intellectual property asset can be identified, categorized, and evaluated upon various market demand criteria, including but not limited to the examples (403) and examples (404). It is understood that the business method 401 can be implemented in any suitable device or system using other suitable components such as a computer having a processor. Moreover, the business method 401 is not limited to the order in which the states are listed in the business method 401. In addition, the flowchart business method 401 can contain a greater or a fewer number of steps than those shown in FIG. 4.

At step 403, an electronic market demand can be evaluated. For example, the electronic market demand can identify criteria (423) regarding products and services, search terms, domain search websites, website searches, sales volumes and web search criteria. For example, information can be collected about the electronic demand for similar and exact domain names in the category of the intellectual asset (403) and graded. Information can be collected about the Internet sales volume of similar and exact products and services in the category of the intellectual asset (403) and graded. Information can be collected about the demand for Internet search terms in the category of the intellectual asset (403) and graded. Information can be collected about the demand for web pages in the category of the intellectual asset (403) and graded. At step 404, data for each grade value by criteria can be combined to determine an electronic rating raw score for each intellectual asset listed by category. That is, a rating can be assigned to the intellectual property assets evaluated for electronic market demand.

At step 405, a conventional market demand can be assessed. For example, the conventional market demand can identify criteria (425) regarding size, industry segment, growth rate and competition. As an example, information can be collected about the web search criteria in the category of the intellectual asset (403) and graded (404). Information can be collected about the conventional market demand for similar and exact products and services in the category of the intellectual asset by industry [0405A] and graded [0405A]. Information can be collected about the conventional demand for similar and exact products and services in the category of the intellectual asset by industry growth rate [0405B] and graded [0405B]. Information can be collected about the conventional demand for similar and exact products and services in the category of the intellectual asset by competitor [0405C] and graded [0405C]. At step 406, data for each grade value by criteria is combined to determine a conventional market rating raw score for each intellectual asset listed by category. That is, data for the electronic market demand [0404] and conventional market demand [0406] can be combined to determine a market demand raw score for each intellectual asset listed by category [0407].

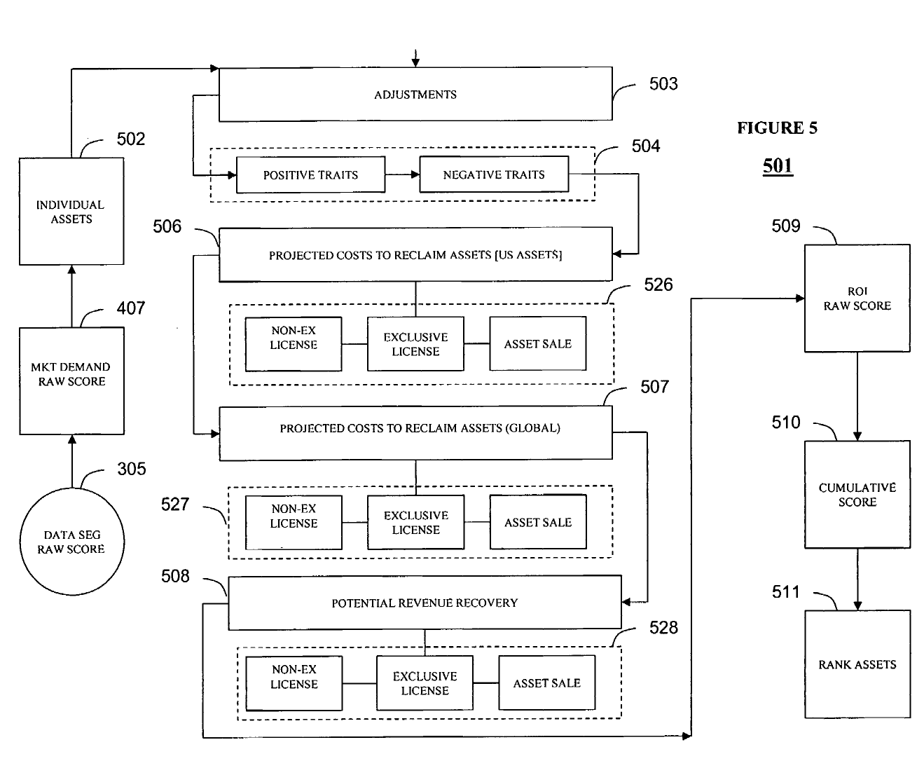

Referring to FIG. 5 a flowchart 501 for determining market opportunity is shown in accordance with one embodiment of the invention. In particular the flowchart 300 corresponds with business method step 501 of FIG. 1 regarding identifying market opportunities for intellectual property assets. It is understood that the business method 501 can be implemented in any suitable device or system using other suitable components such as a computer having a processor. Moreover, the business method 501 is not limited to the order in which the states are listed in the business method 501. In addition, the flowchart business method 501 can contain a greater or a fewer number of steps than those shown in FIG. 5. The business method 501 can include ranking the intellectual property assets based on the intellectual property value in view of market segmentation and market demand for the intellectual property assets, modifying the intellectual property value in accordance with positive and negative traits, projecting costs to reclaim the intellectual property assets, and determining a recovery revenue in view of the projected costs, wherein the intellectual property value is based on one of non-exclusive licenses, exclusive licenses, and a sale of the intellectual property assets.

Briefly referring to FIGS. 3 and 4, raw scores generated for each intellectual property asset through data segmentation (305) and market demand (407) can be combined. At step 502, each intellectual asset can be listed by category and then re-ranked. At step 503, a score and rank of each intellectual property asset can be then adjusted for market opportunity. As an example, the market opportunity can be adjusted a trait (504) such as a positive trait or a negative traits. At step 506, costs can be projected to reclaim domestic assets. For example, projected costs can include exclusive licenses, non-exclusive licenses, and a sale of assets (526). At step 507, costs can be projected to reclaim foreign assets which can include global assets. For example, projected costs can include exclusive licenses, non-exclusive licenses, and a sale of assets (527). At step 508, potential revenue recoveries can be determined. For example, the recovery can include a range of values based upon commercialization methods comprising but not be limited to exclusive licenses, non-exclusive licenses, and a sale of assets.

At step 509, a return on investment (ROI) can be calculated based on the projected domestic costs (506), projected foreign costs (507), and the potential revenue recovery (508). At step 510 a cumulative score can be provided. At step 511, each intellectual property asset can be re-ranked by class and industry category for defining the quality of re-branding or reclamation opportunity presented.

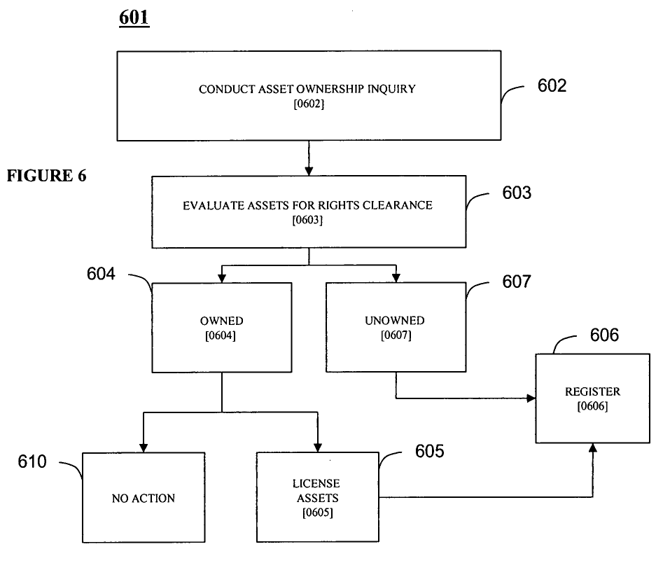

Referring to FIG. 6 a flowchart 601 for conducting an ownership inquiry and acquiring and registering intellectual property is shown in accordance with one embodiment of the invention. In particular the flowchart 600 corresponds with business method step 601 of FIG. 1 regarding ownership inquiry of intellectual property assets. It is understood that the business method 601 can be implemented in any suitable device or system using other suitable components such as a computer having a processor. Moreover, the business method 601 is not limited to the order in which the states are listed in the business method 601. In addition, the flowchart business method 601 can contain a greater or a fewer number of steps than those shown in FIG. 6. The business method 601 can include examining ownership and registration for the intellectual property assets by category, and acquiring rights to re-register the intellectual property assets in at least one category for producing reclaimed intellectual property assets.

At step 602, a review of the rights associated with the identified intellectual property can be undertaken. At step 604, a market opportunity of each intellectual property asset identified can be evaluated in light of the ownership information using certain criteria. The criteria can include determining whether rights are owned or not owned. For example, an intellectual property search on a technology may reveal a number of patents or trademarks that can be combined into a new asset. A search of ownership rights may reveal that the technologies are still under patent protection and ownership. Accordingly, a criteria for determining whether the intellectual property assets should be combined for reclamation and rebranding depend on whether the assets are legally available. For current existing registered assets, inquiries can be made to holders with standard license and/or sales terms to be proposed to existing owners (604). Where holders are agreeable, rights to the assets can be licensed or acquired (605) and re-registered where applicable (606). For unregistered intellectual property assets, or newly developed assets (607), applications can be filed to secure intellectual property.

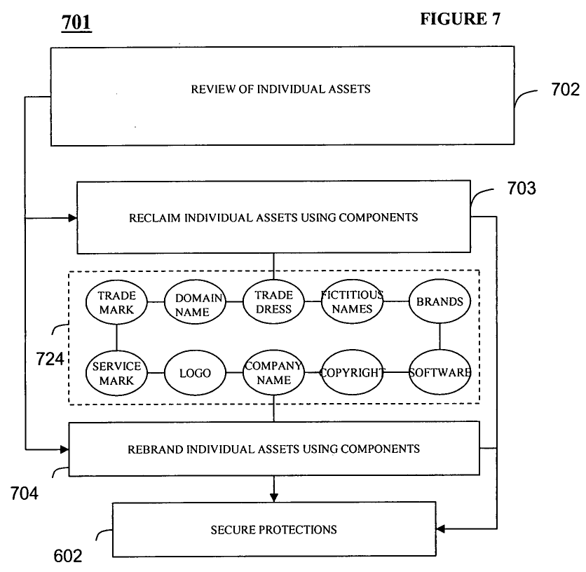

Referring to FIG. 7 a flowchart 701 for reclaiming and re-branding intellectual property assets is shown in accordance with one embodiment of the invention. In particular the flowchart 700 corresponds with business method step 701 of FIG. 1 regarding reclaiming and rebranding intellectual property assets. It is understood that the business method 701 can be implemented in any suitable device or system using other suitable components such as a computer having a processor. Moreover, the business method 701 is not limited to the order in which the states are listed in the business method 701. In addition, the flowchart business method 701 can contain a greater or a fewer number of steps than those shown in FIG. 7.

At step 702, reregistered assets or assets under consideration for use can be assessed for re-combination by category. At step 703, individual assets can be reclaimed based on one or more asset components. For example, but not by way of limitation, common law, trademark and service mark rights can be reviewed to secure identical or substantially similar domain name rights and to tie these to common law and trademark and service mark rights at state and federal law. As another example, but not by way of limitation, domain name rights can be reviewed to secure identical or substantially similar common law, trademark or service marks rights at state and federal law. As yet another example, but not by way of limitation, logos and trade dress can be reviewed to secure common law, trade mark and service mark rights at state and or federal levels and domain name rights.

At step 704, individual assets can be rebranded using asset components. For example, Old or existing intellectual property assets can be combined with other new, reclaimed or re-branded intellectual property including trademarks, service marks, logos, domain names, other IP, including software, and the like. At step 704, protections can be secured for the reclaimed and rebranded intellectual property assets. For example, patent and trademark applications can be filed to secure intellectual property.

Briefly, business step 701 employs a means of reclaiming tarnished and damaged assets, rehabilitating same, and either disposing of such assets on a direct basis through license or sale, whether individually or in bulk, or licensing or holding such assets in portfolio as an investment, whether to create and service a royalty stream or for their future disposition, sale and use.

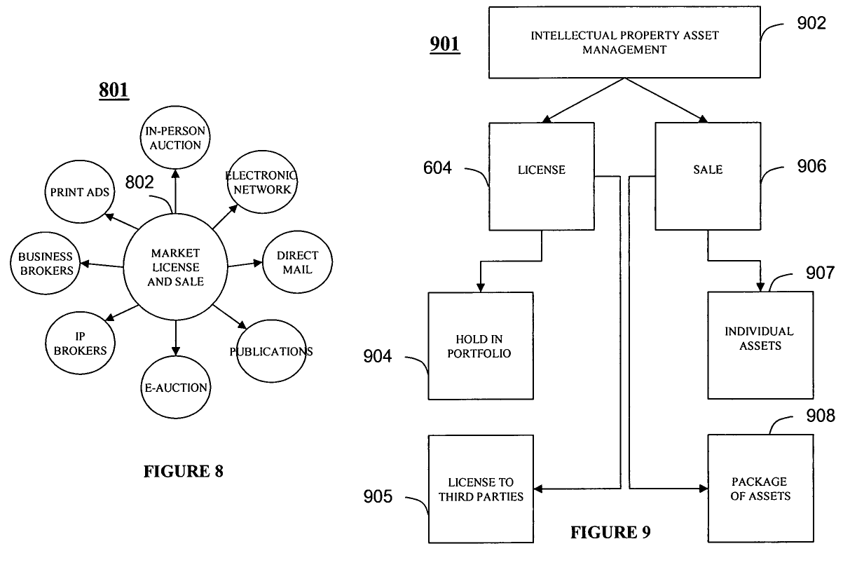

Referring to FIG. 8 a diagram 801 for marketing and promoting reclaimed intellectual property assets is shown in accordance with one embodiment of the invention. In particular the flowchart 800 corresponds with business method step 801 of FIG. 1 regarding the marketing and promotion of intellectual property assets. In particular, the business method 801 can include marketing and promoting reclaimed intellectual property assets for licensing or purchase.

In practice, reclaimed and re-branded intellectual property assets can be marketed through various methods including auctions, electronic auctions, e-commerce sale, e-commerce licensing, direct mail, telemarketing, publications, using sources such as business brokers, e-tailers, intellectual property banks, intellectual property exchanges, secondary markets, and intellectual property agencies as shown in diagram 801. Understandably, embodiments of the invention are not limited to the marketing and promotion aspects shown, and other means for marketing and promoting reclaimed and rebranded intellectual property assets are herein contemplated. Moreover, the promotion and marketing can include software programmable marketing tactics including email, auctions, on-line sales, and the like.

In one arrangement, the business step 801 monetizes intellectual property using “reclaimed or re-branded” intellectual property assets, individually, or in bulk on a commercial basis, in the stated configuration as opposed to on an “as is” basis. The promoting and marketing of reclaimed and re-branded intellectual property assets (802) can be performed directly or indirectly, as a stand-alone asset or group of assets for exclusive and non-exclusive license and/or purchase, in specific territories or globally, using in-person and electronic methods, auctions, and/or electronic rights exchanges.

Referring to FIG. 9 a flow chart 901 for managing intellectual property assets is shown in accordance with one embodiment of the invention. In particular the flowchart 900 corresponds with business method step 901 of FIG. 1 regarding the managing or disposing of intellectual property assets. Notably the steps of the flowchart 901 do not have to be practiced in the order presented. That is, the states may not be dependent on previous steps and may stand alone.

At steps 902, intellectual property assets can be managed. For example, the assets, whether registered or registrable, can be reviewed for recovery of investment through license or sale. At steps 903, Intellectual property assets capable of being licensed may be licensed to generate royalties. Moreover, at steps 904, one or more intellectual property assets may be licensed to third parties with the ownership rights to be held in portfolio and managed. At steps 905, one or more intellectual property assets may be licensed to third parties with the ownership rights to be held by third parties. At steps 906, intellectual property assets capable of being sold may be sold to generate revenues. At steps 907, one or more intellectual property assets may be sold directly to third parties. At steps 908, a group of intellectual property assets may be sold in bulk to third parties.

The licensing of reclaimed and re-branded intellectual property assets (903) can be performed on an exclusive and non-exclusive basis, and/or using a self-determined royalty rate system for licenses. The licenses to one or more of such assets can be held in a financial portfolio (904). Managing the portfolio can include servicing the payments for such assets, managing the continuity of registrations and protections in place, and securing rights against others. The portfolio of intellectual property can be managed to maximize profitability (902). The selling of reclaimed and re-branded intellectual property assets to third parties for their use (906) can be individually (907) or in bulk (908), for direct use, or for sale as a financial asset (907)on a secondary market as described by (908).

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one from another entity or action without necessarily requiring or implying any actual such relationship or order between such entities or actions.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for processing intellectual property assets, comprising:
identifying imperfect intellectual property assets;
reclaiming the imperfect intellectual property assets to produce reclaimed assets;
recombining the reclaimed assets to produce recombined assets;
rebranding the recombined assets to produce rebranded assets; and
monetizing the rebranded assets.

2. The method of claim 1, wherein the identifying further comprises:
collecting data regarding the intellectual property assets, wherein the data identifies one of common law and registered trademarks, patents, service marks, domain names, logos, copyrights, trade dress, company and personal names, fictitious names, or brands including ownership and contact information; and
categorizing the data into categories comprising at least one of actual prior use, scope of use, popularity, status, ubiquity, associated mark, domain name, and novelty.

3. The method of claim 1, wherein the reclaiming further comprises:
examining ownership and registration for the intellectual property assets by category; and
acquiring rights to re-register the intellectual property assets in at least one category for producing reclaimed intellectual property assets.

4. The method of claim 3, wherein the monetizing further comprises:
evaluating a market demand and use of the intellectual property assets by category;
assessing brand awareness for the intellectual property assets; and
marketing and promoting the reclaimed intellectual property assets for licensing or purchase based on the brand awareness,
wherein the marketing and promoting generates brand identities that avoid brand name contention

5. The method of claim 2, wherein the collecting data further comprises:
researching a history of the intellectual property assets; and
combining old and new intellectual property assets with reclaimed intellectual property assets,
wherein the reclaimed intellectual property assets include a combination of common law and registered trademarks, patents, service marks, domain names, logos, copyrights, trade dress, company and personal names, fictitious names, and brands.

6. The method of claim 4, wherein the evaluating a market demand further comprises:
assessing electronic market demand and conventional market demand; and,
employing a grading system to determine an intellectual property value,
wherein the electronic market demand identifies criteria regarding products and services, search terms, domain search websites, sales volumes and web search criteria associated with intellectual property assets,
wherein the conventional market demand identifies criteria regarding size, industry segment, growth rate and competition.

7. The method of claim 6, further comprising:
ranking the intellectual property assets based on the intellectual property value in view of a comparability index and a market demand for the intellectual property assets.
modifying the intellectual property value in accordance with positive and negative traits;
projecting costs to reclaim the intellectual property assets; and
determining a recovery revenue in view of the projected costs, wherein the intellectual property value is based on one of non-exclusive licenses, exclusive licenses, and a sale of the intellectual property assets.

8. The method of claim 3, further comprising:
evaluating intellectual property assets for rights clearance; if rights are owned,
providing no action or offering a license, if rights are not owned,
registering the intellectual property assets.

9. A business method for monetizing intellectual property assets, comprising:
identifying imperfect intellectual property assets;
contacting owners of the imperfect intellectual property assets for acquiring or licensing rights;
reclaiming use of imperfect intellectual property assets in view of said rights to produce reclaimed assets;
evaluating a market demand for the reclaimed assets; and
marketing and promoting the imperfect intellectual property assets,
wherein the imperfect intellectual property comprise at least one from the set consisting of unused, unregistered, abandoned, neglected, out-of-favor and/or terminated intellectual property assets.

10. The business method of claim 9, wherein the marketing and promoting further comprises:
rebranding the reclaimed assets by combining one or more imperfect intellectual property assets to produce rebranded assets; and
selling or licensing the rebranded assets to extract value from the reclaimed and re-branded assets,
wherein the imperfect intellectual property assets are combined with at least one from the set consisting of trademarks, service marks, domain names, logos, copyrights, patents, trade dress, company and personal names, fictitious names, and/or brands into a unique asset independent of any company, product or service.

11. The business method of claim 9, wherein the evaluating a market demand further comprises:
ranking imperfect intellectual property assets by category;
acquiring historical information pertaining to a historical value and demand of the imperfect intellectual property;
estimating a cost for reclaiming and rebranding the imperfect intellectual property;
projecting a reclaimed value based on the cost, the historical value, and the demand; and
performing a defect review to update the reclaimed value of the imperfect intellectual property.

12. The business method of claim 11, further comprising:
comparing the projected reclaimed value with projected licenses or sales returns based on an estimated market size;
revaluing the imperfect intellectual property in view of the projected reclaimed value.

13. The business method of claim 9, further comprising:
determining the ownership and registration status of each intellectual property asset;
distinguishing among assets as to a basis and need for intellectual property protections;
undertaking rights clearance from potential or actual holders on a systematic basis;
acquiring intellectual property rights through licenses;
Securing intellectual property protections for reclaimed and re-branded intellectual property assets; and
asserting intellectual property rights where uncontested rights are available.

14. The business method of claim 10, wherein the rebranding further comprises:
using in whole or part, a common or registered trade or service mark, fictitious name, personal name, brand name, computer designation, logo, history, domain name, e-mail address, regular mail address, post office address; mobile address, trade dress, history, multi-media mark, telephone numbers, avatars, designation of entity status or proprietary operating systems, jurisdiction, develop codes, unique identifiers, conventional or electronic languages, or software programs.

15. The business method of claim 9, wherein the marketing and promoting is performed directly or indirectly, as a stand-alone asset or group of assets, for exclusive and non-exclusive license, for exclusive and non-exclusive purchase, in specific territories or globally, using in-person and electronic methods, auctions, and electronic rights exchanges.

16. The business method of claim 9, wherein the marketing and promoting further comprises auctioning, electronic auctioning, e-commerce selling, e-commerce licensing, direct mailing, telemarketing, publishing, sourcing business brokers, e-tailers, intellectual property banks, intellectual property exchanges, secondary markets, and intellectual property agencies.

17. The business method of claim 9, further comprising:
managing a portfolio re-branded intellectual property assets;
licensing re-branded intellectual property assets; and
holding the license to one or more re-branded intellectual property assets in a financial portfolio.

18. The business method of claim 17, wherein the holding further comprises:
servicing a payments for the reclaimed intellectual property assets;
managing the continuity of registrations and protections in place; and
securing rights against others;

19. A method for intellectual property branding, comprising:
collecting data on imperfect intellectual property assets;
segmenting data based on at least one intellectual property category;
determining a market demand for the imperfect intellectual property assets;
determining a market opportunity for rebranded intellectual property;
conducting ownership inquiries for the imperfect intellectual property; and,
reclaiming and rebranding the imperfect intellectual property,
wherein imperfect intellectual property assets, are at least one of unused, unregistered, abandoned, neglected, out-of-favor and/or in disrepair, no ongoing use, no registrations in place, and no active affiliation to persons, companies, products or services.

20. The method of claim 19, further comprising:
marketing and promoting rebranded intellectual property based on collected data; and
managing rebranded intellectual property assets,
wherein the data identifies one of common law and registered trademarks, patents, service marks, domain names, logos, copyrights, trade dress, company and personal names, fictitious names, or brands including ownership and contact information; and

21. The method of claim 19, further
combining old and new intellectual property assets with reclaimed intellectual property assets,
wherein the reclaimed intellectual property assets include a combination of common law and registered trademarks, patents, service marks, domain names, logos, copyrights, trade dress, company and personal names, fictitious names, and brands.
